(19) United States
(12) Patent Application Publication
(10) Pub. No.: US 2015/0284977 A1
(43) Pub. Date: Oct. 8, 2015

(54) MOTOR VEHICLE DOOR LOCK

(71) Applicant: KIEKERT AKTIENGESELLSCHAFT, Heiligenhaus (DE)

(72) Inventor: Christian Barmscheidt, Duisburg (DE)

(21) Appl. No.: 14/443,670

(22) PCT Filed: Nov. 22, 2013
(86) PCT No.: PCT/DE2013/000701

§ 371 Date: May 19, 2015

(30) Foreign Application Priority Data
Nov. 22, 2012 (DE) 10 2012 111 298.3

(51) Int. Cl. E05B 79/10; E05B 77/28; E05B 77/26; E05B 85/22; E05B 81/06

(52) U.S. Cl. CPC E05B 79/10; E05B 85/22; E05B 81/06; E05B 77/26; E05B 77/28

(57) ABSTRACT

The object of the invention is a motor vehicle door lock, comprising a locking mechanism, an actuating lever chain and a drive for electrically opening the locking mechanism. According to the invention, an additional drive is provided, which optionally transfers the actuating lever chain in its “locked” position and only then generates an opening signal for the drive for electrically opening the locking mechanism.

### CROSS-REFERENCE TO RELATED APPLICATIONS

This application is the U.S. national stage application of International Patent Application No. PCT/DE2013/000701, filed Nov. 22, 2013, which claims priority of German Application No. 10 2012 111 298.3, filed Nov. 22, 2012, which are both hereby incorporated by reference.

### BACKGROUND

The invention relates to a motor vehicle door lock, comprising a locking mechanism, an actuating lever chain and an electric drive for electric opening of the locking mechanism.

A motor vehicle door lock based on the described design is, for instance, described in WO 02/31298 A1 of the applicant. This prior art embodiment not only allows electric opening of the locking mechanism but also provides a mechanical connection between an actuating lever and the locking mechanism for emergency opening of the locking mechanism. In this context this is also referred to as the so-called temporary crash redundancy (TCR). This means that also in a so-called emergency operation or an emergency opening, in case of a crash, it is ensured that the locking mechanism can be mechanically opened, i.e. with the aid of the actuating lever of the actuating lever chain.

Electric opening of a locking mechanism with the aid of the electric drive is regularly accomplished in such a way that the operator activates an external door handle or also an internal door handle. This regularly results in actuation of a switch, interpreted as an opening request. As a result, an opening signal is generated causing the electric drive to be energized for electric opening of the locking mechanism. In order to, already at this point, prevent incorrect energizing from the outset, blocking elements are, for instance, used in practical application. The mechanical blocking element provides a mechanical retention of the electric drive.

Only once the blocking element releases the electric drive can the electric drive electrically open the locking mechanism. The release of the blocking element is regularly linked to mechanical impinging by means of the external door handle or the internal door handle. This means that the external door handle or also the internal door handle is mechanically connected to the blocking element and ensures that the blocking element releases the electric drive so that it can act on the locking mechanism in order to open it. This has generally proven to be successful.

In practical application there are, however, more and more requirements for remote operation of the drive for electric opening of the locking mechanism. In this case, mechanical impinging is not required, as the respective motor vehicle door is to be opened electrically and remotely and without an external door handle also having to be activated. No convincing solutions have so far been provided for this.

### SUMMARY

The invention is based on the technical problem of further developing such a motor vehicle door lock in such a way that a solution is provided that generally also allows remote operation.

In order to solve this technical problem, a generic motor vehicle door lock of the invention is characterized in such a way that an additional drive is provided, moving the actuating lever chain into its “locked” position and that only then an opening signal for the drive is generated for electric opening of the locking mechanism.

The invention thus ensures that the actuating lever chain is always in its “locked” position, even when the electric drive is energized for electric opening of the locking mechanism. Only in case of an emergency opening or in case of a crash, the actuating chain is generally first moved into its “unlocked” position, allowing a respective motor vehicle door to be, for instance, opened by rescue teams. To achieve this, a door handle only has to be mechanically activated.

This means that the motor vehicle door lock of the invention contains the already described “temporary crash redundancy” (TCR). In the event of an accident the electric drive, providing electric opening of the locking mechanism, ensures that during emergency operation the locking mechanism can be mechanically redundantly opened. This operation is independent of the electric drive.

The invention now ensures that electric opening of the locking mechanism with the aid of the drive can always and only occur when a respective opening signal has been generated. In other words, the locking and electric opening are always linked in such a way that mechanical locking is not possible without opening. The opening signal requires the actuating lever chain to first have assumed or have been moved into its “locked” position. In this context, the additional drive naturally does not need to mechanically act on the actuating lever chain if said chain has already assumed its “locked” position. This means that the additional drive moves the actuating lever chain in its “locked” position when required.

Only once the “locked” position of the actuating lever chain has been attained, is said opening signal is generated, causing the electric drive to be energized for electric opening of the locking mechanism.

This means that the actuating lever chain permanently retains its “locked” position. In this way a release lock is provided, ensuring that the actuating lever chain is retained in the “locked” position. As a result, any mechanical actuation of the actuating lever chain cannot result in opening of the locking mechanism. Opening can also not be provided by the electric drive for electric opening of the locking mechanism as no opening signal is applied. Maximum safety is thus ensured.

At the same time the invention offers the option to remotely operate the drive for electric opening of the locking mechanism. For this purpose, the additional drive is ultimately impinged on, moving the actuating lever chain into its “locked” position when required. At the same time, impinging of the additional drive ensures that the required opening signal is generated in order for the drive, facilitating electric opening of the locking mechanism, to be even started. The opening signal is generally only generated when the actuating lever chain has reached its “locked” position. For this purpose, the additional drive is, in most cases, designed in such a way that, when impinged on in the “locked” direction of the actuating lever chain at the end of the range of travel, the respective opening signal is also generated.

Further details and advantageous embodiments are disclosed in the sub claims. Below, the invention is explained in detail with reference to a drawing showing only one embodiment, in which:

### BRIEF DESCRIPTION OF THE DRAWINGS

FIGS. 1 to 3 show the motor vehicle door lock of the invention in different operating positions.

### DETAILED DESCRIPTION OF THE DRAWINGS

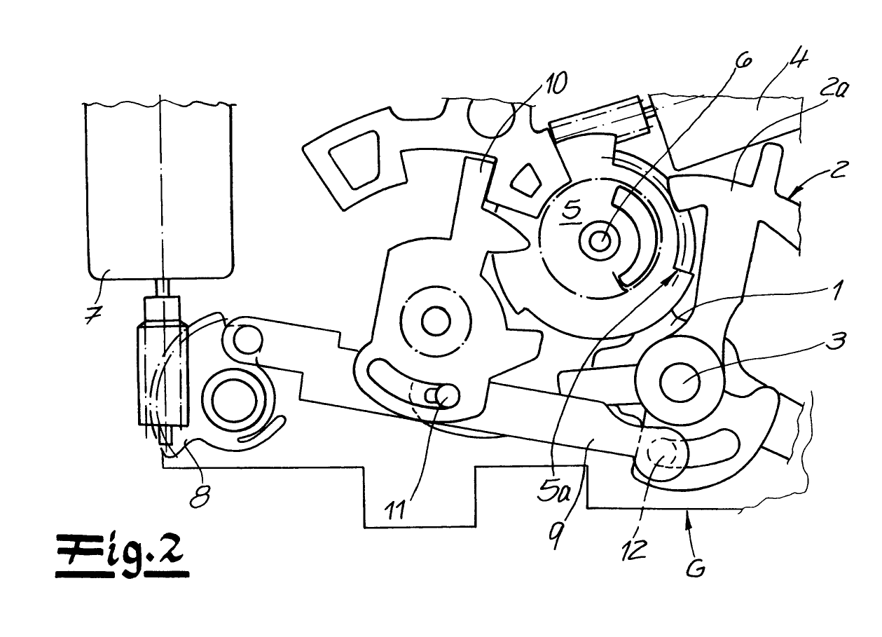

The figures show a motor vehicle door lock containing a not explicitly shown locking mechanism, essentially comprising a rotary latch and a pawl. In order to impinge on the locking mechanism, the motor vehicle door lock contains a triggering lever 1 only shown in FIG. 2. Together with a blocking element or blocking lever 2 the triggering lever 1 is mounted in a lock housing 4 to rotate around a common axis 3.

In order to open the locking mechanism, the triggering lever 1 must be pivoted around its axis 3 in clockwise direction, as indicated by a respective arrow in FIG. 2. In order to facilitate this pivoting movement of the triggering lever 1 in clockwise direction, a drive 4, 5 is provided for electric opening of the locking mechanism. The drive 4, 5 comprises an electric motor 4 and a driven pulley 5 that can carry out the rotary movements initiated by the electric motor 4 in clockwise and counter-clockwise direction around its axis 6.

Movement of the driven pulley 5 in counter-clockwise direction around its axis 6 ensures that a contour located at the rear, when viewed from the top, interacts with the triggering lever 1 in such a way that the triggering lever 1 is pivoted around its axis 3 in clockwise direction. As a result, the locking mechanism is opened by the triggering lever 1, pivoting the pawl of the locking mechanism away from the respective rotary latch and opening the rotary latch by means of a spring. This releases a locking bolt previously retained by the rotary latch. The clockwise movement of the driven pulley 5 corresponds, on the other hand, to an emergency opening and at the same time to the locking mechanism being mechanically openable.

In addition to the already described drive 4, 5 for electric opening of the locking mechanism, the figure also shows an additional drive 7, 8, used by the invention, having a design similar to that of drive 4, 5. The additional drive 7, 8 actually also consists of an electric motor 7 and a driven pulley 8. As in case of drive 4, 5 the electric motor 7 contains a worm gear at its drive shaft, meshing with gears on the external circumference of the driven pulley in order to pivot the driven pulley 8 around its axis 9 in clockwise or counter-clockwise direction.

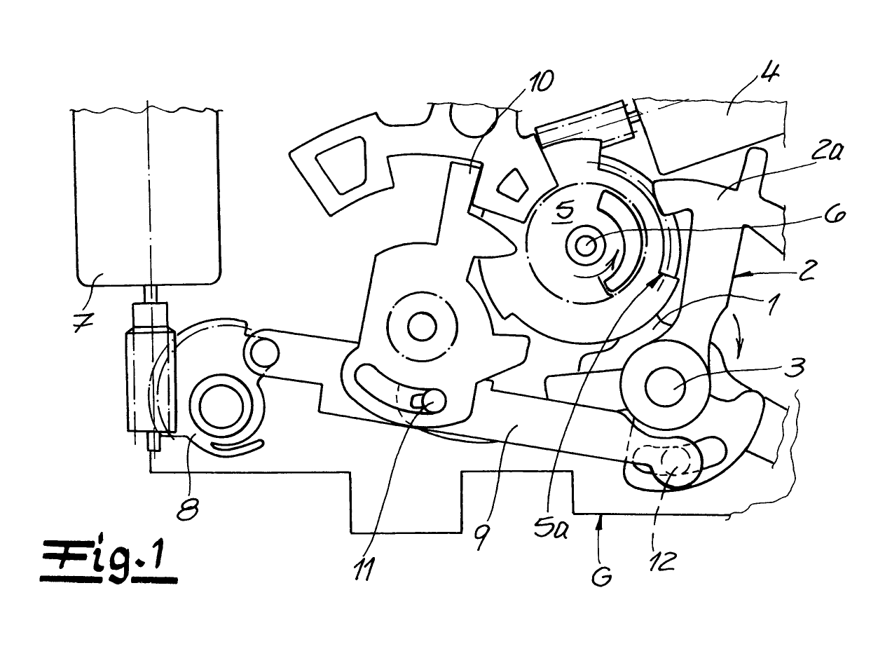

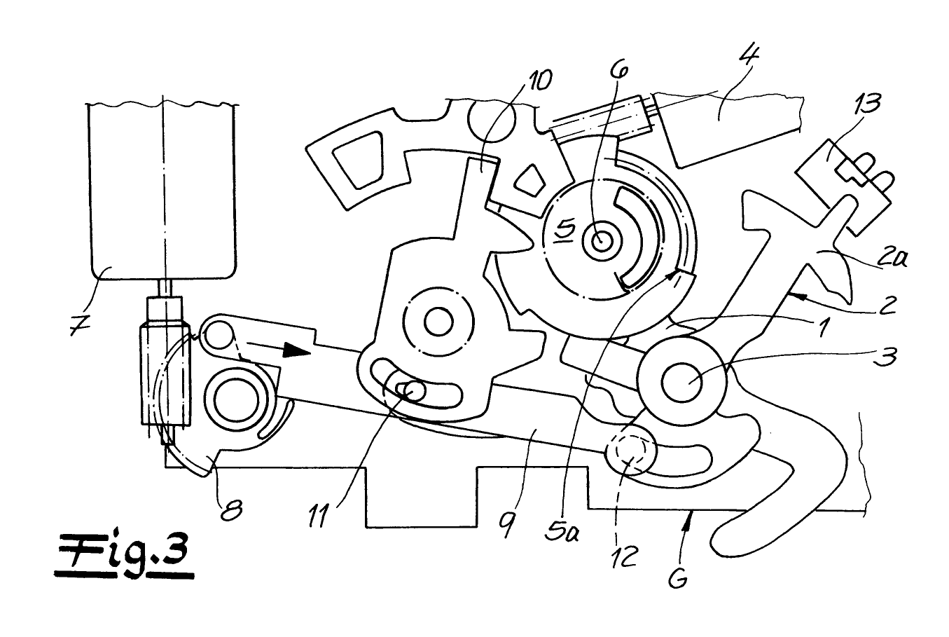

In the embodiment, the additional drive 7, 8 is a safety drive. The safety drive can operate as a child lock drive and/or anti-theft device drive. In the example, the additional drive 7, 8 or safety drive is a child lock drive. This drive acts on a locking lever 10 mounted in the lock housing 4 to rotate around its axis 11. The locking lever 10 can essentially assume an “unlocked” position as shown in FIG. 1 or can be moved into position 30 “locked” as shown in FIGS. 2 and 3.

The locking lever 10 is actually always located in its “locked” position as a release lock is provided as explained in more detail below. Only in case of a so-called emergency opening, is the locking lever 10 typically moved into its “unlocked” position as shown in FIG. 1, so that in this (rare) case, an actuating lever mechanism or an actuating lever chain 12, 13, 14 is effective and can mechanically open the locking mechanism.

The general design also includes the aforementioned actuating lever mechanism or actuating lever chain 12, 13, 14. Apart from an actuating lever 12 the actuating lever mechanism 12, 13, 14 contains an additional coupling lever 13 interacting or not interacting with the triggering lever 1, depending on its position. The connection lever 12 and the coupling lever 13 can then also be mechanically connected to the triggering lever 1 by means of an intermediate lever 14 and depending on the position of the coupling lever 13.

When the actuating lever chain 12, 13, 14 is in its “locked” position, the actuating lever chain 12, 13, 14 is mechanically interrupted and no continuous mechanical connection between, for instance an external or internal door handle up to the triggering lever 1 exists. In contrast, the “unlocked” position of the actuating lever chain 12, 13, 14 corresponds to the triggering lever 1 by means of which the actuating lever chain 12, 13, 14 can be mechanically impinged on for opening the locking mechanism. In the example embodiment this is only the case and only feasible, when a so-called emergency opening occurs or should occur.

The additional drive 7, 8 or child lock drive is mechanically connected to the actuating lever 12. The actuating lever 12 is actually flexibly connected to the driven pulley 8 of the additional drive 7, 8. With the aid of the actuating lever 12 connected to the additional drive 7, 8, said additional drive 7, 8 acts on the coupling lever 13 of the actuating lever mechanism 12, 13, 14.

For this purpose the actuating lever 12 contains a locking pin 15, engaging in an associated recess on the locking lever 10. In this way the actuating lever 12 can pivot the locking lever 10 for instance into the positions “locked” or “unlocked” and can thus provide the child lock function. In addition, an actuating pin 16 is provided with the aid of which the coupling lever 13 engages in a recess of the intermediate lever 14.

It is apparent that the additional drive 7, 8 acts on a sensor 17 when the actuating lever mechanism 12, 13, 14 is in the “locked” position. This sensor 17 can be a child lock sensor or child lock switch 17. Only when the respective sensor 17 is acted upon is said opening signal generated, causing the drive 4, 5 to be energized for electric opening of the locking mechanism. This means that the electric opening process of the locking mechanism requires a signal of the sensor 17 to be registered by a control unit—not shown—to which the sensor 17 is connected.

For the sensor 17 to be impinged on, the additional drive 7, 8 finally reaches the position shown in FIG. 3 from its position “off or child lock off” as shown in FIG. 1 during the transition to FIG. 2, corresponding to the position “on or child lock on”. Only once the additional drive 7, 8 has reached the position shown in FIG. 3 is the sensor 17 also acted upon accordingly allowing the drive 4, 5 to electrically open the locking mechanism.

In this way the invention ensures that, on one hand, the locking lever 10 definitively assumes or retains its “locked” position, whilst the counter-clockwise movement of the driven pulley 8 of the additional drive associated with the transition from the “off” to the “on” position corresponds to the locking lever 10 being pivoted around its axis 11 in clockwise direction as required, as shown in the transition from FIG. 1 to FIG. 2. Simultaneously with the movement of the additional drive 7, 8 the actuating lever chain 12, 13, 14 is moved into its “locked” position in which no continuous mechanical connection to the triggering lever 1 exists. Any mechanical impinging on the actuating lever chain 12, 13, 14 does thus not result in an unwanted opening of the locking mechanism. The signal of the sensor 17 generated in this manner is now interpreted as an opening signal and ensures that the drive 4, 5 electrically opens the locking mechanism.

Once the “on” position shown in FIG. 3 has been reached by the additional drive 7, 8, a spring-loaded return is activated with which the additional drive 7, 8 is equipped. This spring-loaded return ensures that the driven pulley 8 carries out a small clockwise movement around its axis 9 caused by a spring or a driven pulley 8. As a result, the actuating lever chain 12, 13, 14 is mechanically closed as required or can move into its “unlocked” position. As already explained, the additional drive 7, 8 is generally acted upon by remote control so that the described electric opening of the locking mechanism can be initiated without making contact.

1. Motor vehicle door lock comprising a locking mechanism, an actuating lever chain and a drive for electrically opening the locking mechanism, characterized in that an additional drive is provided which optionally transfers the actuating lever chain into its “locked” position and only then generates an opening signal for the drive for electrically opening the locking mechanism.

2. Motor vehicle door lock according to claim 1, characterized in that the additional drive contains an electric motor and a driven pulley.

3. Motor vehicle door lock according to claim 1, characterized in that the additional drive acts on a coupling lever of the actuating lever mechanism via a connected actuating lever.

4. Motor vehicle door lock according to claim 3, characterized in that the actuating lever contains a locking pin for engaging in a recess on a locking lever.

5. Motor vehicle door lock according to claim 3, characterized in that the actuating lever or the coupling lever contain an actuating pin (16) for engaging in a recess of an intermediate lever.

6. Motor vehicle door lock according to claim 1, characterized in that the additional drive is designed as a safety drive, for instance a child lock and/or anti-theft device drive.

7. Motor vehicle door lock according to claim 1, characterized in that the additional drive acts on a sensor when the actuating lever mechanism is in the “locked” position.

8. Motor vehicle door lock according to claim 7, characterized in that the sensor is a child lock sensor and generates the opening signal together with a control unit.

9. Motor vehicle door lock according to claim 1, characterized in that the additional drive can be operate by remote control.

10. Motor vehicle door lock according to claim 1, characterized in that the additional drive contains a spring-loaded return.

11. Motor vehicle door lock according to claim 2, characterized in that the additional drive acts on a coupling lever of the actuating lever mechanism via a connected actuating lever.

12. Motor vehicle door lock according to claim 11, characterized in that the actuating lever contains a locking pin for engaging in a recess on a locking lever.

13. Motor vehicle door lock according to claim 12, characterized in that the actuating lever or the coupling lever contain an actuating pin (16) for engaging in a recess of an intermediate lever.

14. Motor vehicle door lock according to claim 13, characterized in that the additional drive acts on a sensor when the actuating lever mechanism is in the “locked” position.

15. Motor vehicle door lock according to claim 14, characterized in that the additional drive can be operate by remote control.

16. Motor vehicle door lock according to claim 15, characterized in that the additional drive contains a spring-loaded return.

17. Motor vehicle door lock according to claim 4, characterized in that the actuating lever or the coupling lever contain an actuating pin (16) for engaging in a recess of an intermediate lever.

18. Motor vehicle door lock according to claim 17, characterized in that the additional drive acts on a sensor when the actuating lever mechanism is in the “locked” position.

19. Motor vehicle door lock according to claim 18, characterized in that the additional drive can be operate by remote control.

20. Motor vehicle door lock according to claim 19, characterized in that the additional drive contains a spring-loaded return.
